(19) United States
(12) Patent Application Publication
(10) Pub. No.: US 2019/0013766 A1
(43) Pub. Date: Jan. 10, 2019

(54) MOBILE RENEWABLE ENERGY POWER GENERATOR, MANAGEMENT SYSTEM, AND DISTRIBUTED ENERGY RESOURCES

(71) Applicant: John Stach, Grand Rapids, MI (US)

(72) Inventor: John Stach, Grand Rapids, MI (US)

(21) Appl. No.: 15/644,437

(22) Filed: Jul. 7, 2017

(51) Int. Cl. H02S 10/40; H02J 3/38; H02J 7/00; H01R 27/02; H01R 25/00

(52) U.S. Cl. CPC H02S 10/40; H02J 3/383; H01R 25/006; H02J 7/0013; H01R 27/02; H02J 3/386

(57) ABSTRACT

An apparatus, system, and method are disclosed for generating, storing and managing stored power from renewable resources. The apparatus includes a portable power generator that generates, distributes, and leverages power. The apparatus leverages power by converting alternating current to direct current and distributing power systematically. In this manner, stored power is utilized more efficiently, and the advantages of a steady direct current are realized. Only the minimal power required is generated, thereby protecting sensitive electrical devices from power fluctuations. The apparatus also detects and alerts to fluctuations in voltage and current. The apparatus can link with other power generators to form a multiplier effect for the wattage. The apparatus recharges from a renewable energy power source to eliminate the need for fossil fuels and reduce pollution and noise.

### FIELD OF THE INVENTION

This invention relates to generators, and more particularly relates to portable renewable energy generators which generate, distribute, leverage, and recharge power within a distributed system.

### BACKGROUND

### Description of the Related Art

Interest in renewable energy and the generation of green energy is growing due to increasing energy demands on traditional grid systems as well as to government incentives and subsidy programs. Distributed generation (DG)-power sources connect at one or more locations within a distribution system. Utility companies face grid-integration problems arising with new DG power sources, as well as voltage regulation, system stability and power quality issues, and there exist no efficient mobile apparati in the art for managing and storing energy generated from a variety of DG power sources.

Power requirements in remote locations, including short term power requirements, typically require the use of a mobile or portable gas- or diesel-powered generator often in locations in which fossil fuels are unavailable and impractical to import. Renewable energy system, such as photovoltaic farms, are often constructed to provide the required power in whole or in part. Traditional fossil fuel power generator also includes numerous heavy, moving parts that reduce the efficiency of the generator and make transport difficult. Consequently, traditional generators are difficult to move from one problem situs to another. Even where traditional generators using fossil fuels are location, the combustive effect of power generator which use fossil fuels often generates pollution, noise, and smoke. An object of the present invention is to provide a portable, renewable energy storage and management system which minimizes dependence on fossil fuels and increases incentives for consumers to make use of distributed power.

Traditional power generators convert mechanical or kinetic energy to electrical energy. Forms of mechanical energy include reciprocating or turbine steam engines, cascading water driving a turbine or waterwheel, an internal combustion engine, a wind turbine, a hand crank, compressed air, or any other source of mechanical energy.

Most traditional generators do not include batteries for supplying stored direct current. Direct current is most often used for supplying power to vehicles, powering small electrical devices such as microprocessors, and charging batteries. Although alternating current generators exist in the art which have rectifiers that convert alternating current to direct current or vice versa, most distributed sources feed direct current to generators which must be stored in batteries.

Efficient, mobile power generators which store and manage power generated from renewable energy and distributed energy resources are unknown in the art. There exists a need in the art for an efficient mobile energy storage and management apparatus which can store in batteries and provide reliable continuous power for small residential and commercial application, and which can alternatively provide alternating current or direct current, and which is capable of running all standard residential and small commercial devices, including pumps, air conditioners, refrigerators, and the like.

In view of the foregoing, it is clear that these traditional power generators are not perfect and that more optimal apparati for storing, managing, and making power available are needed in the art.

### SUMMARY

From the foregoing discussion, it should be apparent that a need exists for a mobile renewable energy power generation and management system. Beneficially, such an apparatus, system, and method would provide a plurality of features and components efficacious for generating, leveraging, and distributing power to and from an eclectic assortment of electrical devices in an efficient manner.

The present invention has been developed in response to the present state of the art, and in particular, in response to the problems and needs in the art that have not yet been fully solved by currently available apparatus. Accordingly, the present invention has been developed to provide a power generator for storing, managing and distributing electrical current derived from renewable energy, the generator comprising: a rigid polymeric housing defining two or more recesses, including an output panel recess for receiving an output panel and an input panel recess for receiving an input panel, the rigid polymeric housing further defining two semicircular recesses, each semicircular recess for receiving a wheel; two wheels affixed to an axle, the axle driven by an electric adjustable-speed drive control system which comprises a motor and a controller, the controller comprising a twist handle rotatable to apply increasing torque to the axle; an inverter; the output panel comprising: a nonconductive polymeric faceplate having a planar top surface; four NEMA 110 volt A/C sockets recessed into the faceplate, each of the four NEMA 110 volt A/C sockets having a maximum output capacity of one of 15 amps and 20 amps; one or more 220 volt A/C sockets recessed into the faceplate, the 220 volt A/C sockets having a maximum output capacity of 60 amps; one or more 110 volt A/C sockets recessed into the faceplate, the 110 volt A/C sockets having a maximum output capacity of 30 amps; a master switch adapted to shut down all power being input or output from the generator; an invertor switch adapted to activate the inverter; six or more LEDs, each LED adapted to indicate electrical connectivity between the generator and an external device; an output D/C power meter adapted to display power being output by the generator to external devices; an input D/C power meter adapted to display power being input to the generator by external sources; the input panel comprising: a nonconductive polymeric faceplate having a planar top surface; a 220 volt A/C charge input; a switch adapted to shut off all power being input to the generator; a plurality of solar inputs for receiving current from one or more photovoltaic cells; a 110 volt A/C charge socket; a plurality of batteries for storing energy imparted to the generator via the input panel.

The generator may further comprise one more 48 volt Anderson connectors. The output panel may alternatively comprise a plurality of resets, each reset adapted to open and close a circuit including only a single socket on the output panel.

In various embodiments, the generator further comprises a plurality of casters. The top surface of the housing may define a plurality of elongated recesses. Each battery may comprises a 12 volt, 225 ampere, sealed, deep cycle battery.

The generator may further comprise a power linkage module comprising a 1.2 volt direct current plug in cord, and/or a 120 volt alternating current cord, and/or a booster cable for joining the apparatus with the at least one electrical device.

In still further embodiments, the generator further comprises a power fluctuation module comprising a low voltage alarm, the low voltage alarm being operable to detect one or more of a deep battery discharge, a voltage spike, a current spike, and a transferred energy spike, the low voltage alarm further being operable to emit an alarm upon detection of one or more of the deep battery discharge, the voltage spike, the current spike, and the transferred energy spike.

The generator may be configured to supply 14,000 watts continuously. The generator may further comprise: a power leverage module configured to at least partially convert the alternating current to the direct current; a power linkage module configured to join the apparatus with one or more of one electrical device and at least one generator; a power fluctuation module configured to at least partially restrict a fluctuation of the power and to alert to the fluctuation of the power; a power recharge module configured to at least partially recharge the apparatus, the power recharge module comprising a renewable energy power source; and a power display module configured to display a status of the power.

The power leverage module may further comprise a current switching device, the current switching device comprising a rectifier. The power linkage module may further comprise a 48 volt Anderson cord with a female connector, and a 100 amp Anderson cord with two male connectors for joining the apparatus with the at least one apparatus, whereby a wattage generated by the apparatus and/or the at least one generator combine to form a sum wattage.

In still further embodiments, the power fluctuation module further comprises a transfer switch, the transfer switch being operable to switch the power between the apparatus and the electrical device during an interruption in the power.

The renewable energy power source may comprise one or more of a solar panel and a wind turbine. The power recharge module may further comprise an alternating current cord, the alternating current cord being configured to join the apparatus with the at least one electrical device.

A system for storing, managing and distributing electrical current derived from renewable energy is also provided, the system comprising: a rigid polymeric housing defining two or more recesses, including an output panel recess for receiving an output panel and an input panel recess for receiving an input panel, the rigid polymeric housing further defining two semicircular recesses, each semicircular recess for receiving a wheel, the housing defining two or more semicircular recesses for receiving wheels and a plurality of parallel elongated recesses in a top surface of the housing; two or more wheels affixed to an axle, the axle driven by an electric adjustable-speed drive control system which comprises a motor and a controller, the controller comprising a twist handle rotatable to apply increasing torque to the axle; an inverter; the output panel comprising: a nonconductive polymeric faceplate having a planar top surface; four NEMA 110 volt A/C sockets recessed into the faceplate, each of the four NEMA 110 volt A/C sockets having a maximum output capacity of one of 15 amps and 20 amps; one or more 220 volt A/C sockets recessed into the faceplate, the 220 volt A/C sockets having a maximum output capacity of 60 amps; one or more 110 volt A/C sockets recessed into the faceplate, the 110 volt A/C sockets having a maximum output capacity of 30 amps; a master switch adapted to shut down all power being input or output from the generator; an invertor switch adapted to activate the inverter; six or more LEDs, each LED adapted to indicate electrical connectivity between the generator and an external device; an output D/C power meter adapted to display power being output by the generator to external devices; an input D/C power meter adapted to display power being input to the generator by external sources; the input panel comprising: a nonconductive polymeric faceplate having a planar top surface; a 220 volt A/C charge input; a switch adapted to shut off all power being input to the generator; a plurality of solar inputs for receiving current from one or more photovoltaic cells; a 110 volt A/C charge socket; a plurality of batteries for storing energy imparted to the generator via the input panel, each battery comprising a 12 volt, 225 ampere, sealed, deep cycle battery; a power leverage module configured to at least partially convert the alternating current to the direct current; a power linkage module configured to join the apparatus with one or more of one electrical device and at least one generator; a power fluctuation module configured to at least partially restrict a fluctuation of the power and to alert to the fluctuation of the power; a power recharge module configured to at least partially recharge the apparatus, the power recharge module comprising a renewable energy power source; and a power display module configured to display a status of the power.

The renewable energy power source to the system may comprise one or more of a solar panel and a wind turbine. The system may further comprise one more 48 volt Anderson connectors.

The output panel may likewise as previously mentioned comprises a plurality of resets, each reset adapted to open and close a circuit including only a single socket on the output panel.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a forward side perspective view illustrating one embodiment of a mobile apparatus for storing and managing power in accordance with the present invention;

FIG. 2 is an exploded side perspective view illustrating one embodiment of an outlet panel of a mobile apparatus for storing and managing power in accordance with the present invention;

FIG. 3 is an exploded side perspective view illustrating one embodiment of an input panel of a mobile apparatus for storing and managing power in accordance with the present invention;

FIG. 4 is a top side perspective view illustrating one embodiment of a mobile apparatus for storing and managing power in accordance with the present invention;

FIG. 5 is a sectioned side perspective view illustrating one embodiment of a mobile apparatus/system for storing and managing power in accordance with the present invention;

FIG. 6 in a block diagram illustrating one embodiment of a power linkage module in accordance with the present invention;

FIG. 7 in a block diagram illustrating one embodiment of a power linkage module in accordance with the present invention;

FIG. 8 in a block diagram illustrating one embodiment of a distributed power system in accordance with the present invention;

FIGS. 9A, 9B, and 9C are perspective views illustrating different embodiments of the recharging module in accordance with the present invention;

FIG. 10A is a top perspective view illustrating different embodiments of a semitrailer having a plurality of photovoltaic cells in accordance with the present invention;

FIG. 10B is a forward perspective view illustrating one embodiment of a wind-powered distributed energy source positioned on a stationary vehicle, in accordance with the present invention;

FIG. 10C is a side perspective view illustrating one embodiment of a wind-powered distributed energy source positioned on a stationary vehicle, in accordance with the present invention; and

FIG. 10D is a forward perspective view illustrating one embodiment of a wind-powered distributed energy source positioned on a stationary vehicle, in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

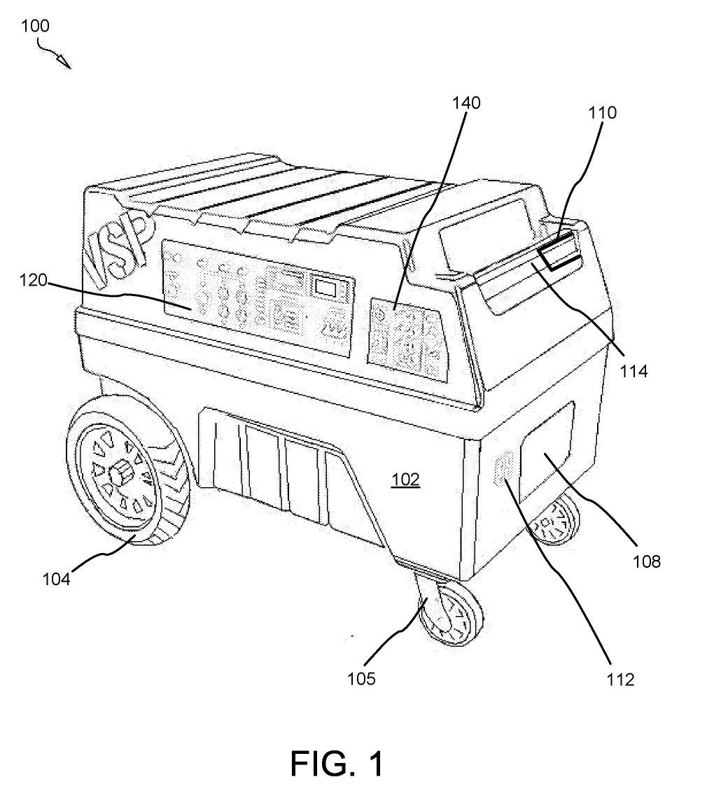

FIG. 1 is a forward side perspective view illustrating one embodiment of a mobile apparatus 100 for storing and managing power in accordance with the present invention.

The apparatus 100 stores and transmits varying amounts of wattage, including up to 14,000 watts or more. In the present invention, an apparatus 100 may store mechanical energy which has been converted to electrical energy, then direct this current through a transfer switch or using other means known to those of skill in the art to a residence, commercial building or the like, in the form of watts, voltage, and amps. The apparatus 100 may include a variety of power generators, including, without limitation, an electromagnetic generator, a dynamo generator, an induction generator, a magnetohydrodynamo generator, a homopolar generator, and an electrostatic generator. In one embodiment, a first power generator may generate 700 watts, while a second power generator may have the capacity to generate 14,000 watts. Those skilled in the art, in light of the present teachings, will recognize that the first power generator and the second power generator may be linked in series or in parallel to combine the wattage produced. In this manner, large quantities of power may be generated without requiring larger, more costly apparatus.

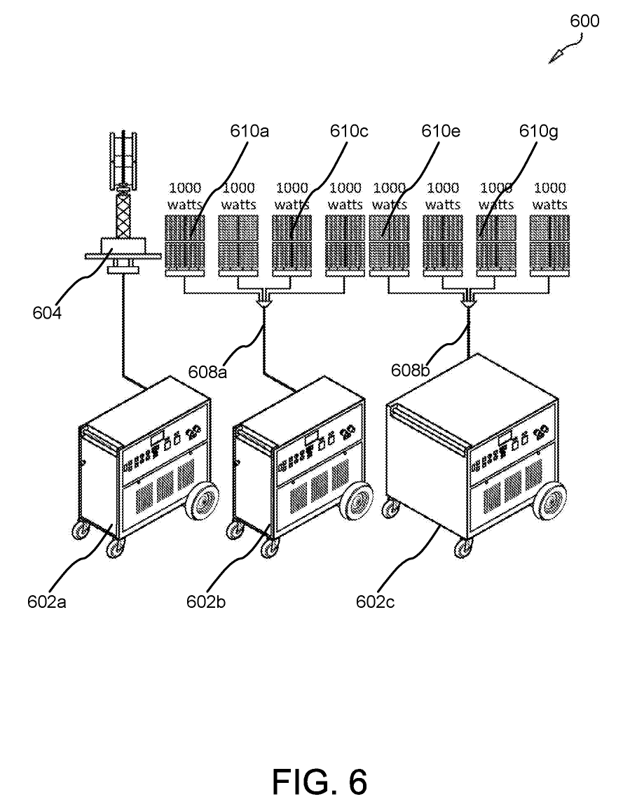

In one embodiment of the present invention, the apparatus 100 includes a power source module for receiving and storing both alternating current and direct current. The power source module includes at least one battery (as further described below in relation to FIG. 5 and other figures). The at least one battery may include, without limitation, a nickel-cadmium battery, a lead-acid battery, and a lithium ion battery, with each battery having varying amounts of voltages, or other batteries known to those of skill in the art. In some embodiments, the apparatus 100 is configured to leverage power by converting alternating current to direct current or vice versa using devices known to those of skill in the art, including current switching devices such as rectifier. Rectifiers contain electronic elements or electromechanical elements that allow current to flow only in one direction. Direct current may be made into alternating current with an inverter or a motor-generator set.

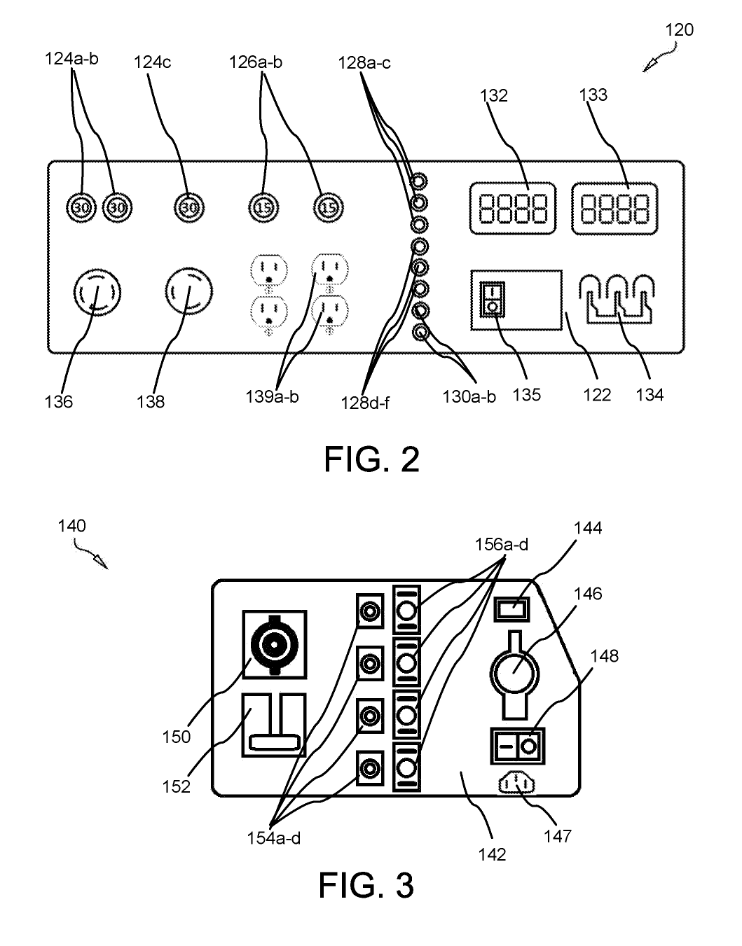

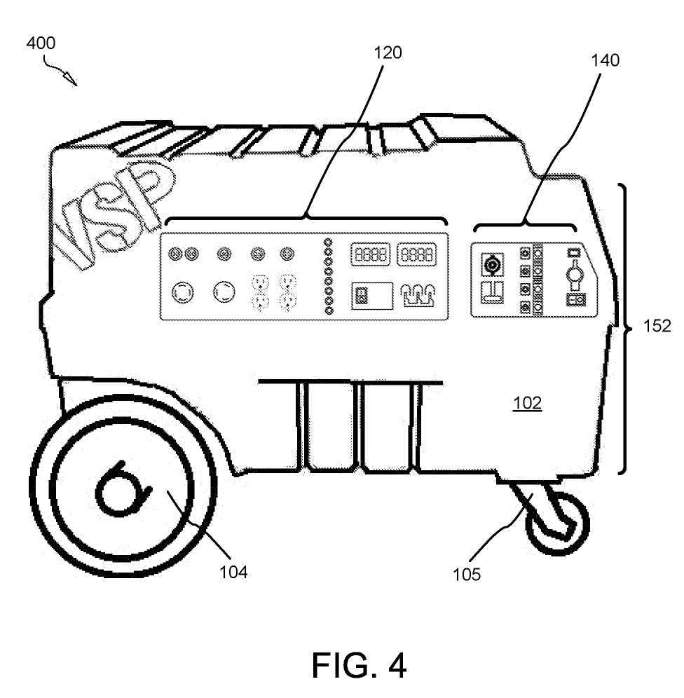

In yet another embodiment, the power leveraging system or component allows the apparatus 100 to produce only the minimal required power for the electrical component in electrical connectivity with the apparatus 100, so as to conserve energy and protect power sensitive electrical equipment from power surges to preserve stored power. The apparatus 100 includes at least one outlet panel 120 (further described below in relation to FIG. 2) configured to receive various currents and wattages. The apparatus 100 likewise includes at least one input panel 140 (further described below in relation to FIG. 3). In some embodiments, the at least one outlet panel 120 comprises sockets and plug in receptors that are configured to receive power cords, booster cables, conductors, converters, and link circuits. In this manner, the apparatus 100 joins with various electrical components and other apparatus to provide, receive, distribute, and leverage power. In yet another embodiment, the apparatus 100 is equipped to regulate emergency power outages and power surges through built in transfer switches, low voltage alarm and shutdown components, and surge protection features.

The apparatus 100 comprises a rigid polymeric housing 102 for containing the components the apparatus 100 further comprises. The housing 102 defines a hollow interior recess and may be sectioned into concave top and bottom housing units. In various embodiments, the housing 102 is generally cubic in shape, defining exterior recesses for accommodating wheels 104.

The housing 102 defines at least two recesses for receiving panels 120-140, including the output panel 120 (or output control panel 120) and the input panel 140.

A rigid cylindrical handle 114 forms in the housing 102 or is affixed thereto. The handle 114 may be tubular or solid and may be fabricated from polymeric, metallic, metal alloy, or organic components (i.e, wood). An axially-rotating outer handle 110 (or twist handle) affixes over the handle 114 which is used to activate an internal drive system or transport system which includes an electrically-activated transmission for driving the rear wheels 104 forward or backward (i.e., clockwise or counterclockwise). The apparatus 100 may comprise two handles 110, each for activating a separate wheel 104 to facilitate turning of the apparatus 100 in place.

The apparatus 100 further comprises Anderson connectors 112 for receiving current from photovoltaic arrays, wind turbines, and other distributed power sources. The housing 102 may define an aperture or traversing recess 108 for receiving a vent and/or dissipating heat.

The apparatus 100 may comprise a built-in, two-way transfer switch.

FIG. 2 is an exploded side perspective view illustrating one embodiment of an output control panel 120 of a mobile apparatus 100 for storing and managing power in accordance with the present invention.

In the present invention, the apparatus 100 includes hardware adapted to, configured to, and necessary or optionally desired to link the apparatus 100 with at least one external electrical device so as to receive and/or provide power. The apparatus 100 may link to an external transfer switch to power a residential or commercial building. Various cords serve to join the output panel 120 (or output control panel 120) with internal storage and management components within the housing 102.

The panel 120 includes sockets and joining components. Cords attach and detach with the panel 120 such as a 120 volt power cord, and a direct current cord, such as a 12 volt plug in, all which may be utilized to join the apparatus 100 with the at least one electrical devices.

The panel 120 comprises a nonconductive, polymeric faceplate 122 which is planar on its outer and inner surfaces.

The panel 120 comprises a plurality of resets 124, 126 (or circuit breakers 124, 126). In place of the resets 124, 126, or addition thereto, the panel 120 may alternatively comprise a plurality of fuses, including cartridge fuses, surface mount fuses, axial radial thru hole fuses, or other fuses known to those of skill in the art. The breaking capacity of these fuses 124, 126 may be 14 amps, 30 amps, or other maximum amperages, voltages or watts. Each fuse 124, 126 on the panel 120 operates to provide overcurrent protection to the electrical output (or socket) disposed directly beneath it on the panel 120.

For instance, current exceeding 30 amps through socket 136 triggers the circuit breaker 124a, 124b to prevent damage caused by excess current resulting typically from an overload or short circuit and to interrupt current flow. The circuit breakers 124a-d, 126 must be manually reset after fault triggers them by depressing the circuit breaker 124, 126.

Further, a link circuit, such as an Anderson connector 112 may join a plurality of generators to provide a multiplier effect for generating wattage. The Anderson connector 112 may position on the housing 102, the output panel 120, or the input panel 140.

The panel 120 comprises a plurality of electrical power plugs (or sockets), including A/C sockets 136, 138, and 139a-b. Sockets 139a-b may comprise NEMA 5-15 or NEMA 5-20RA, or NEMA 5-20R sockets for receiving NEMA 5-15 plugs and/or other standard electrical plugs. Sockets 139a-b may be rated for up to 125 volts and 20 amps. Sockets 139a-b may together form a duplex socket.

Socket 136 may comprise a standard A/C 220 volt, 60 hertz socket. Two 30 amp, 220 volt resets 124a-b are disposed above socket 136 on the panel 120.

Socket 138 may comprise a standard 110 volt, 60 hertz socket. A single 30 amp, 220 volt reset 126 is disposed above socket 136 on the panel 120.

Sockets 139a-b may comprise standard 110-125 volt, 60 hertz sockets, each with an associated 15 amp reset 126 positioned above.

The panel 120 comprises a plurality of control panel lights 128 (or indicators). These lights 128 comprise LEDs (light emitting diodes) in the shown embodiment. Each light 128 indicates various input or output stati, including the input of solar current (indicated in the shown embodiment by light 128a). There are eight lights 128 in the shown embodiment, each associated with a separate function of the apparatus 100.

In one embodiment of the present invention, a power display module may be included in the apparatus 100 for automating electrical information gathering processes from the apparatus 100. The power display module includes electrical devices with lights 128 and electronic message signs. In one embodiment, the power display module may include a digital display that provides power consumption and power efficiency information.

The panel 120 comprises an output D/C power meter 132 for displaying the power in watts being output by the apparatus 100 to one or more external electrical devices. The panel 120 comprises also comprises an input D/C power meter 133 for displaying the power in watts being input to the apparatus 100 by one or more distributed power sources.

The panel 120 also comprises an inverter switch 135 for activating and deactivating a power inverter housed within the housing 102.

A main power switch 134 is affixed to the panel 120 for shutting off all power being output and/or input to the apparatus 100. The main power switch 134 is known to those of skill in the art.

FIG. 3 is an exploded side perspective view illustrating of an input panel 140 of a mobile apparatus for storing and managing power in accordance with the present invention.

The panel 140 comprises a 220 volt A/C charge input 150 as known to those of skill in the art for inputting current to the apparatus 100 for storage in one or more batteries. A switch 152 shuts off power input to input 150.

The shown panel 140 also comprises a plurality of solar inputs 154a-d, 156a-d as known to those of skill in the art.

The panel 140 may also comprise an 110-125 volt A/C charge socket 147 and/or a computer interface port 146 and/or a switch 148 for activating one or more inputs to the panel 140.

The panel 140 may further comprise an auto fuel generator start button 144 for activating a device external to the apparatus 100, including an external generator comprising a reciprocating fuel-combustion engine.

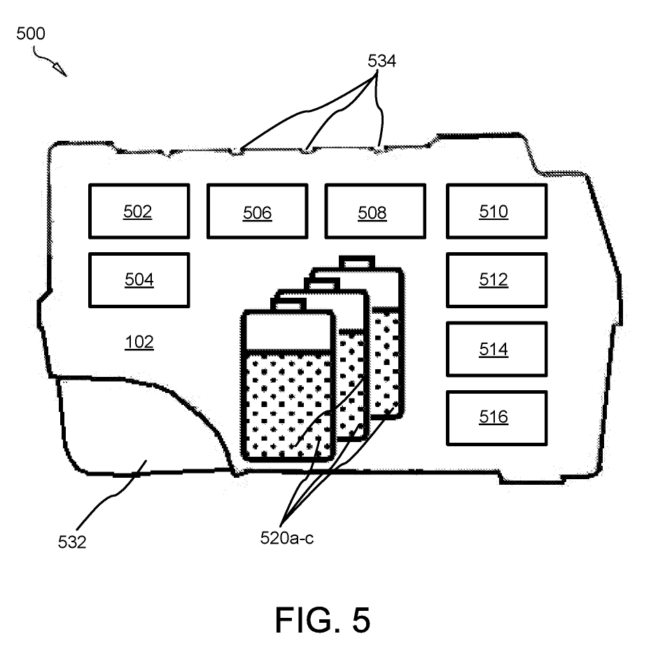

FIG. 4 is a top side perspective view illustrating one embodiment of a mobile apparatus 400 for storing and managing power in accordance with the present invention.

The apparatus 400 has a forward end 152 (or distal end) and includes the housing 102, the output panel 120 and the input panel 140, as well as wheels 104, 105.

The apparatus 400 is configured, in one embodiment, to distribute or generate and utilize both alternating current and direct current. In this manner, the direct current may function to recharge the batteries 520 and provide a steady power supply, and house hold electrical devices may utilize the alternating current. The at least one outlet panel 120 provides a plurality of outlets or sockets for joining the apparatus 400 with electrical devices and at least one apparatus. The at least one outlet panel includes an alternating current panel having four panels with three-prong alternating current outlets. The at least one outlet panel also includes a direct current panel to join the apparatus with 12 volt electrical devices, such as vehicle batteries and cigarette lighter sockets.

FIG. 5 is a sectioned side perspective view illustrating one embodiment of a mobile apparatus/system 500 for storing and managing power in accordance with the present invention.

The housing 102 is sectioned showing a plurality of internal modules 504-516. The apparatus 500 includes a power leverage module 504. The power leverage module 504 is configured to, or adapted to, leverage power by converting alternating current to direct current. In some embodiments, the power leverage module 502 converts the alternating current to a direct current with a current switching device, such as a rectifier 502. In this manner, the direct current may provide several advantages, including, without limitation, greater stability, since less equipment is needed to synchronize a steady direct current than the sine waves of alternating current; and easier integration of multiple power sources, since primary sources such as photovoltaic, flywheels, and batteries all produce energy in the direct current format. The power leverage module 504 may include, without limitation, a rectifier, an AC/DC converter, and an AC/DC adapter.

The apparatus 500 includes a transport module 506, which may includes one to four wheels 104 and a motor for powering the movement and maneuverability of the apparatus 500. The movement may include, without limitation, forward movement, rear movement, turning, and variable speeds. In one embodiment, the transport module includes a 12 volt motor that powers a pair of 8″ rear wheels 104, and a pair of 4″ front wheels 105 that swivel (on casters in some embodiments) for turning capabilities. However, in other embodiments, the wheels 104-105 may be replaced by rails, tracks, or sleds. The transport module includes 506 a transport control switch 110 in the form of one or more handles for controlling movement of the apparatus 500. The transport control switch includes a hand operated switch that regulates directional movement and speed of the apparatus 500. In one embodiment, the apparatus 500 includes substantially no moving parts. In this manner, manufacturing problems, such as high production costs and potential break downs are minimized.

The transport module 506 may comprise an electric adjustable-speed drive control system which includes one or more motors and controllers to adjust the operating speed of the rear wheels 104 using internal power.

The apparatus 500 requires no fossil fuels to operate, rather utilizing renewable energy power sources to recharge the at least one battery 520. The transport module 506 may be powered from the apparatus itself.

In the present invention, the apparatus 500 includes a power linkage module 508 configured to joins the apparatus 600 with at least one external electrical device so as to receive and/or provide power. Various cords serve to join the apparatus with the at least one electrical device. For example, without limitation, an alternating current cord, such as a 120 volt power cord, and a direct current cord, such as a 12 volt plug in, may be utilized to join the apparatus with the at least one electrical devices. Further, a link circuit, such as an Anderson connector 112 may join a plurality of generators to provide a multiplier effect for generating wattage.

The apparatus 500 comprises a power fluctuation module 510 in accordance with the present invention. The power fluctuation module 510 is configured to protect against interruption in power, such as emergency power outages. The power fluctuation module 510 may include a built-in transfer switch operable to switch a power load from the normal utility power source to the apparatus when the utility source fails. Suitable transfer switches may include, without limitation, an open transfer switch, a closed transfer switch, a soft load transfer switch, and a static transfer switch. The apparatus 500 is further configured to restrict fluctuations in power. The power fluctuation module 510 includes a low voltage alarm that triggers a shutdown when the apparatus generates an undesired amount or type of power. In one embodiment, the low voltage alarm utilizes a low voltage circuitry to monitor the at least one battery and other volatile sources of current for problems. The low voltage alarm sounds an alarm and lights a light emitting diode 128 when a problem is detected. In this manner, deep battery discharge, voltage spikes, current spikes, and transferred energy spikes may at least partially be controlled.

The apparatus 500 may utilize various power cords to recharge the at least one battery, including, without limitation, a 1.2 volt direct current plug joined with a vehicle cigarette lighter, a 50 amp alternating current battery charger, and a booster cable joined with a vehicle. The apparatus 500 may also comprise an inverter 512.

A power display module 514 may be included in the apparatus 500 (further described below), a recharging module 516 (further described below), as well as one or more additional modules. The power display module 514 may be configured to include a digital display 133 for automating an electrical information gathering processes from the apparatus and attached electrical devices. In some embodiments, the power display module 514 utilizes light emitting diode 128 systems and electronic message signs. However, in other embodiments, a mechanical display device may be utilized to gather and display the information. The power display module 514 provides electrical readings for the apparatus 500 and connected electrical devices and power sources, including, without limitation, charge level, power consumption, transfer switch status, alternating current charge, and alternating current voltage output. In this manner, the amount of power consumption and efficiency rate may be viewed and available time to generate power may be calculated. In one embodiment, the power display module 514 may display the following electrical readings on the digital display:
Input Volts—Indicates the amount of voltage entering the apparatus when an alternating current cord mates with a 110/120 volt plug;
Invertor Volts: Indicates the voltage output to the plugs from the 120 or 220 volt invertors;
Battery Volts: Indicates the amount of voltage in the at least one battery;
Current Amps: Indicates the amount of amperage being drawn from the apparatus;
Temperature: Indicates the ambient temperature; and
Power in Watts: Indicates the amount of watts being drawn from the apparatus.

The housing 102 defines two or more semicircular recesses 532 for receiving and/or partially enveloping a wheel 104. The housing also comprises a plurality of elongated recesses 534 oriented in parallel (or alternatively crisscrossing) for preventing objects resting on the top surface of the housing 102 from sliding when the apparatus 500 is moved.

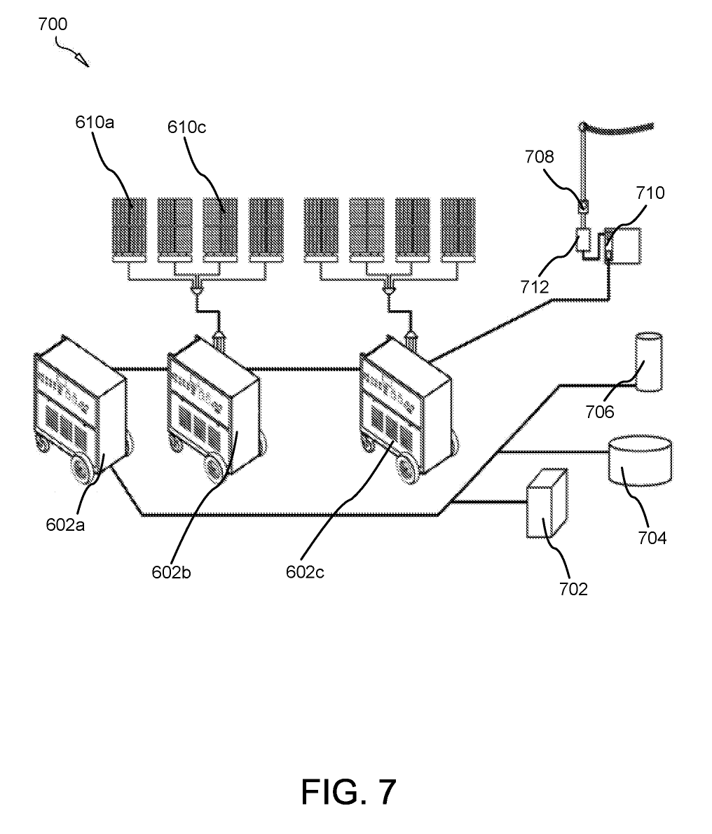

FIG. 6 in a block diagram illustrating one embodiment of a power linkage module 508 as well as functions of the apparatus 600 in accordance with the present invention.

The power linkage module 508 may leverage power with at least one generator 602 in accordance with the present invention. The power linkage module 508 may be configured to form a link-circuit 600 with at least one generator 602, whereby a wattage 604 generated by each generator is combined to form a sum wattage. The power linkage module 508 can form an energy network by providing a link-circuit between each generator, whereby each generator contributes wattage to the total sum of wattage produced. For example, without limitation, a 1.4 kilowatt apparatus 602c linked with two seven hundred watt apparati 602a-b may generate a total of 2.8 kilowatts of power in either a series or parallel circuitry. In yet another embodiment, the power linkage module includes one or booster cables 608 for charging batteries 520 internal to the generator 602 using one or more distributed energy power sources 610. The power linkage module may also be operable to link the apparati 602 to the at least one electrical device 610 for receiving and providing power.

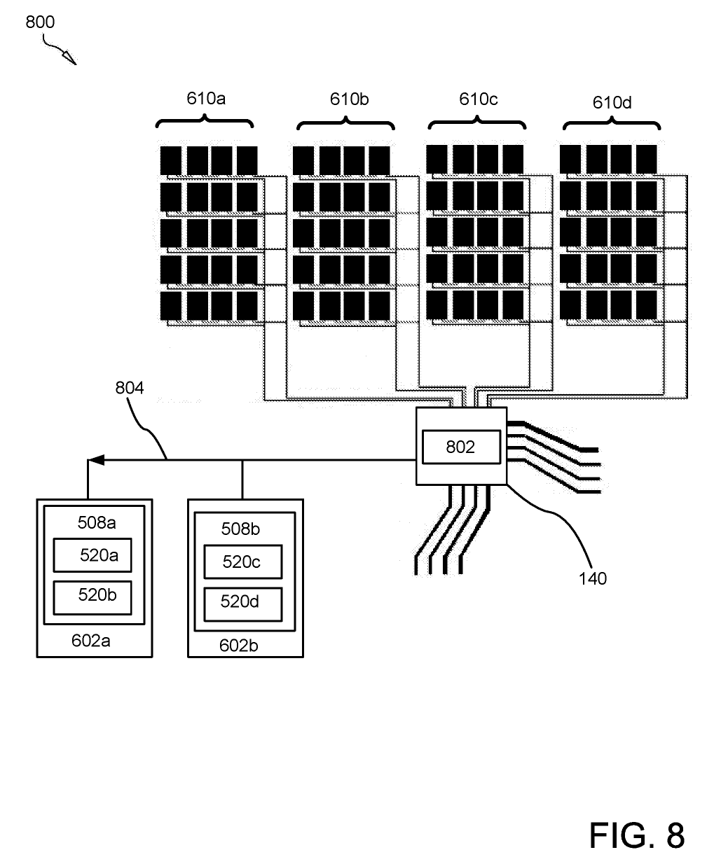

FIG. 7 in a block diagram illustrating one embodiment of a power linkage module and system of electrically-interconnected apparati in accordance with the present invention.

The generator 602a may comprise a hybrid gas electric generator or a renewable energy generator 100. The generators 602 collectively or individually power one or more of a furnace 702, a central air conditioning unit 704, an electric water heater 706, and other similar devices used in residential and commercial environments as known to those of skill in the art. A metal base 708 is included, as well as main switch 712 and a distribution electric panel 710.

Photovoltaic cells 610 or photovoltaic cell arrays 610 input power into the generators 602 in some embodiments.

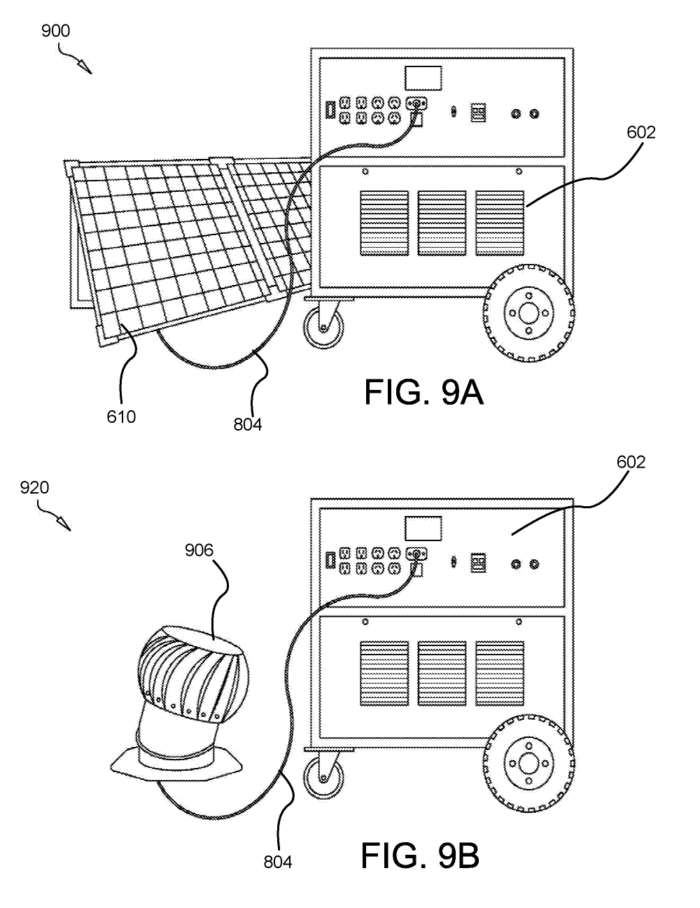

FIG. 8 in a block diagram illustrating one embodiment of a distributed power system 800 in accordance with the present invention. The system 800 comprises four external power sources 610 further described above and below, as well as two generators 602a-b. Each generator 602 comprises a power linkage module 508 and batteries 520.

The power system 800 includes an automatic transfer switch 802 and input panel 140. Current 804 in input to the batteries 520.

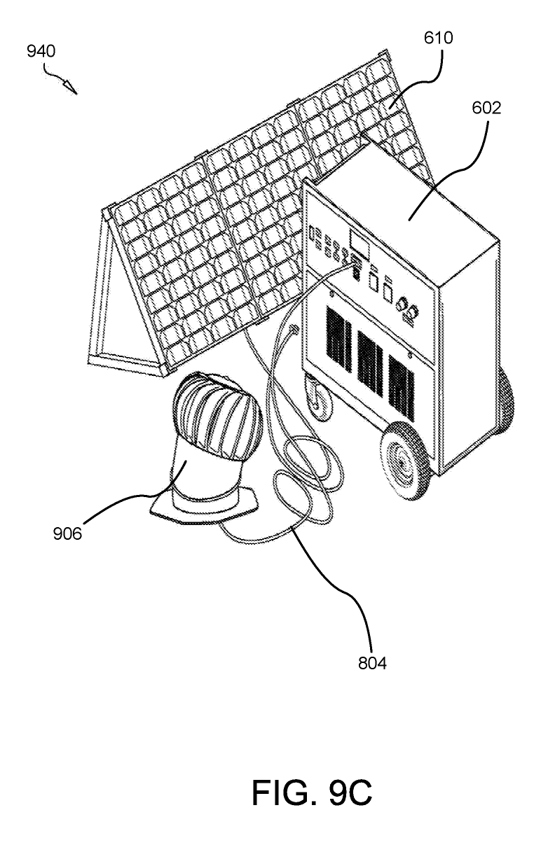

FIGS. 9A, 9B, and 9C depict different embodiments of the recharging module 516 in accordance with the present invention. In the present invention, a power recharge module 516 utilizes renewable energy 804 to recharge at least one battery 520. The at least one battery 520 may include a rechargeable battery that requires recharging after the power has been depleted. In another embodiment, the power recharge module 516 transmits power 804 from the renewable energy power source to an electric device via the apparatus 500. Renewable energy power sources, such as a solar panel(s) 610 and/or a wind turbine 906, may attach with the apparatus 500 to recharge the at least one battery 520. The solar panel 610 may include a photovoltaic system comprising an array of solar panels, an inverter, a solar tracker, and interconnection wiring. The solar panel 610 produces energy in proportion to the square area of each panel. The wind turbine 906 may be operable to convert kinetic energy from the wind into mechanical energy, which then transfers to the apparatus to produce electricity. Those skilled in the art, in light of the present teachings, will recognize that the power recharge module 516 does not require storing the renewable energy power prior to distribution, but rather, may immediately distribute the power 804 while attached to the renewable energy power source; in essence serving as a conduit for the solar panel or wind turbine. In some embodiments, the solar panel 610 may generate one hundred watts, two hundred watts, or one thousand watts. The wind turbine 905 may generate hundreds of watts or one thousand watts. However, other quantities are possible, for example when a plethora of solar panels 610 are networked together. In this manner, the apparatus 500 does not require fossil fuels, such as diesel, and minimizes noise and pollution while in operation. Both solar panel 610 and wind turbines 906 may be simultaneously interconnected with one or more generators 602.

In the present invention, the apparatus 500 includes an alternating current cord that attaches to an alternating current plug 150. In yet another embodiment, a direct current cord attaches to a cigarette lighter socket. The power cords that join the at least one outlet panel with the electrical device may include, without limitation: a 48 volt/20 amp alternating current charger with auto shutoff, a 120 volt/60 Hertz/15 amp three-prong North American plug, and a 120 volt/60 Hertz/30 amp trailer type plug-in.

The apparatus 500 may include, without limitation a booster cable. The booster cable is efficacious for charging a vehicle by attaching to the at least one electrical device, such as a vehicle battery. Conversely, a direct current cord mates with a female cigarette socket wired for 48 volts/200 amps to charge the apparatus from the vehicle.

The apparatus 500 may comprise a transport control switch such as handle 110 in accordance with the present invention. In the present invention, a transport module is operable to maneuver the apparatus, allowing for portability, including, without limitation, forward movement, rear movement, turning, and variable speeds. In some embodiments, the transport module includes a transport control switch, whereby movement of the apparatus is regulated. The transport module may utilize various means to move, including, without limitation, wheels, tracks, and rails.

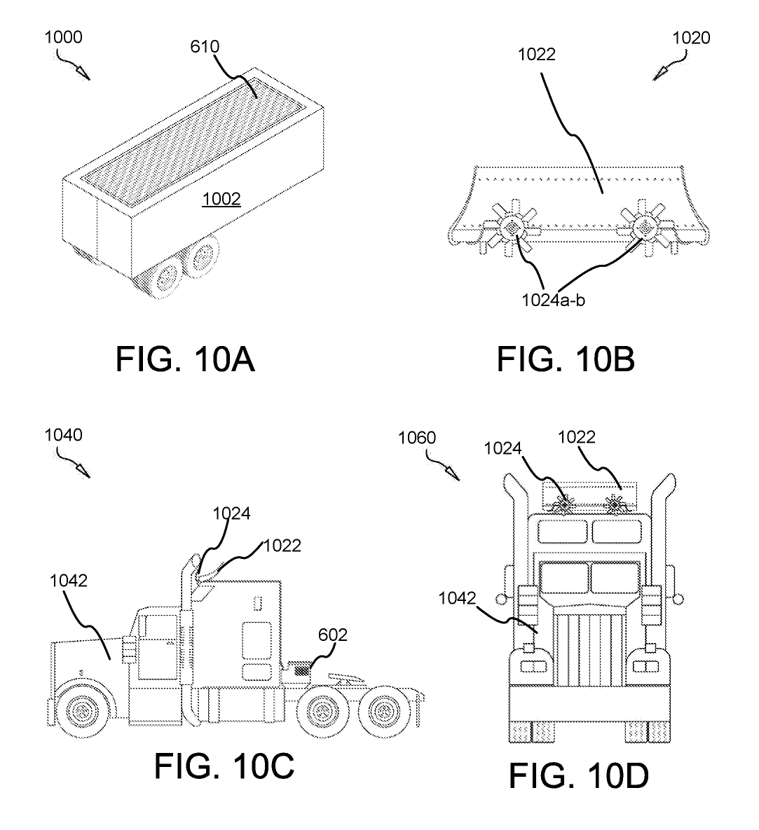

FIG. 10A is a top perspective view illustrating different embodiments of a semitrailer having a plurality of photovoltaic cells in accordance with the present invention.

The semi truck trailer 1002 may comprise one or more solar cells 610 for supplying current to an onboard generator. The at least one solar cell 610 produces electrons when the solar radiation strikes the semiconductor. In one embodiment, the at least one solar energy cell 610 includes five solar films, each generating 1,000 watts.

FIG. 10B is a forward perspective view illustrating one embodiment of a wind-powered distributed energy source positioned on a stationary vehicle, in accordance with the present invention.

At least one wind turbine 1024 positions on a vehicle or a vehicle for converting the kinetic energy of wind motion produced by movement of the vehicle into mechanical energy to generate power for recharging the generator 500. In this manner, the at least one wind turbine 1024 can recharge the generator 500 only while the vehicle moves in an orientation operable for receiving and converting the wind motion. For example, without limitation, the at least one wind turbine 1024 positions on a roof area of the vehicle and orients towards the front of the vehicle 1024 for receiving wind kinetic energy while moving in a forward direction. The force of the wind turns blades on the wind turbine 1024, and a rotor converts the slow rotation of the blades into a quicker rotation that is more suitable to drive an electrical generator that positions in the at least one wind turbine 1024. A wind barrier 1022 positions behind each wind turbine 1024 to provide enhanced aerodynamics and fuel efficiency for the vehicle. The at least one wind turbine 1024 may include, without limitation, a horizontal-axis wind turbine 1024, a vertical-axis wind turbine, a towered wind turbine, a Darrieus wind turbine, and a Savonius wind turbine. In one embodiment, the at least one wind turbine 1024 includes, without limitation, two adjacently positioned, forward oriented 15 amp turbines operable to generate 30 amps of electricity per hour while the vehicle 100 is moving. A spacing of about 6-10 times the turbine rotor diameter may be utilized to prevent contact by the blades and maximize efficiency.

In one embodiment, the power generated by the at least one wind turbine 1024 may combine with the power generated by the at least one solar cell 610 to recharge a battery 520 in the generator 500. In this manner, the generator 602 may store and distribute power to the vehicle without necessitating help from the engine or vehicle battery. Those skilled in the art will recognize that the at least one solar cell 610 or the at least one wind turbine 1024 may be utilized simultaneously or separately for generating electricity to recharge the generator 602. For example, a cloudy day does not affect the at least one wind turbine 1024, and a stationary vehicle does not affect the at least one solar cell 610.

FIG. 10C is a side perspective view illustrating one embodiment of a wind-powered distributed energy source positioned on a stationary vehicle, in accordance with the present invention.

The power generator 602 recharges through renewable energy devices, including those 610, 1024 joined with a semi-trailer truck 1042 or trailer 1002. In the present invention, the system 1040 includes a power generator 602 that positions on a vehicle 1042, and is operable to recharge through renewable energy resources and generate power for the vehicle 10242 while the vehicle 1042 is in a stationary position and powered off. However, in other embodiment, the power generator 602 may also generate power for the vehicle 1024 while the vehicle 1024 is mobile, or while the vehicle 1024 is stationary yet still operating in a capacity. The vehicle 1024 may include, without limitation, a semi-trailer truck 1042, a pickup truck, a dump truck, an automobile, and a mobile home. Those skilled in the art, in light of the present teachings, will recognize that trucks may allow a user to sleep, cook, and enjoy entertainment from a vehicle 1042 cabin. These vehicle 100 functions require electricity, which is supplied by the generator 102 without necessitating powering on a vehicle engine. In some embodiments, the generator 602 is configured to regulate and store the electricity generated by the renewable energy devices, convert direct current to alternating current, and actuate the desired functions for the vehicle 100. In this manner, energy is produced while the vehicle 1042 is either stationary or mobile, and energy conservation is achieved for minimizing fuel consumption.

FIG. 10D is a forward perspective view illustrating one embodiment of a wind-powered distributed energy source positioned on a stationary vehicle, in accordance with the present invention.

The at least one wind turbine 1024 includes a turbine generator that produces electricity in response to the blades rotating from wind kinetic energy. The at least one wind turbine 1024 includes two turbines, each wind turbine 1024 providing 15 amperes of electricity per hour when the vehicle 1042 is in motion against the wind. In some embodiments, the power generated by each renewable energy device may travel through a cable that joins with the generator 602.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A power generator for storing, managing and distributing electrical current derived from renewable energy, the generator comprising:
a rigid polymeric housing defining two or more recesses, including an output panel recess for receiving an output panel and an input panel recess for receiving an input panel, the rigid polymeric housing further defining two semicircular recesses, each semicircular recess for receiving a wheel;
two wheels affixed to an axle, the axle driven by an electric adjustable-speed drive control system which comprises a motor and a controller, the controller comprising a twist handle rotatable to apply increasing torque to the axle;
an inverter;
the output panel comprising:
a nonconductive polymeric faceplate having a planar top surface;
four NEMA 110 volt A/C sockets recessed into the faceplate, each of the four NEMA 110 volt A/C sockets having a maximum output capacity of one of 15 amps and 20 amps;
one or more 220 volt A/C sockets recessed into the faceplate, the 220 volt A/C sockets having a maximum output capacity of 60 amps;
one or more 110 volt A/C sockets recessed into the faceplate, the 110 volt A/C sockets having a maximum output capacity of 30 amps;
a master switch adapted to shut down all power being input or output from the generator;
an invertor switch adapted to activate the inverter;
six or more LEDs, each LED adapted to indicate electrical connectivity between the generator and an external device;
an output D/C power meter adapted to display power being output by the generator to external devices;
an input D/C power meter adapted to display power being input to the generator by external sources;
the input panel comprising:
a nonconductive polymeric faceplate having a planar top surface;
a 220 volt A/C charge input;
a switch adapted to shut off all power being input to the generator;
a plurality of solar inputs for receiving current from one or more photovoltaic cells;
a 110 volt A/C charge socket;
a plurality of batteries for storing energy imparted to the generator via the input panel.

2. The generator of claim 1, further comprising one more 48 volt Anderson connectors.

3. The generator of claim 1, wherein the output panel comprises a plurality of resets, each reset adapted to open and close a circuit including only a single socket on the output panel.

4. The generator of claim 1, further comprising a plurality of casters.

5. The generator of claim 1, wherein the top surface of the housing defines a plurality of elongated recesses.

6. The generator of claim 1, wherein each battery comprises a 12 volt, 225 ampere, sealed, deep cycle battery.

7. The generator of claim 1, further comprising a power linkage module comprising a 1.2 volt direct current plug in cord, and/or a 120 volt alternating current cord, and/or a booster cable for joining the apparatus with the at least one electrical device.

8. The generator of claim 1, further comprising a power fluctuation module comprising a low voltage alarm, the low voltage alarm being operable to detect one or more of a deep battery discharge, a voltage spike, a current spike, and a transferred energy spike, the low voltage alarm further being operable to emit an alarm upon detection of one or more of the deep battery discharge, the voltage spike, the current spike, and the transferred energy spike.

9. The generator of claim 1, wherein the generator is configured to supply 14,000 watts continuously.

10. The generator of claim 1 further comprising:
a power leverage module configured to at least partially convert the alternating current to the direct current;
a power linkage module configured to join the apparatus with one or more of one electrical device and at least one generator;
a power fluctuation module configured to at least partially restrict a fluctuation of the power and to alert to the fluctuation of the power;
a power recharge module configured to at least partially recharge the apparatus, the power recharge module comprising a renewable energy power source; and
a power display module configured to display a status of the power.

11. The generator of claim 1, wherein the power leverage module further comprises a current switching device, the current switching device comprising a rectifier.

12. The generator of claim 1, wherein the power linkage module further comprises a 48 volt Anderson cord with a female connector, and a 100 amp Anderson cord with two male connectors for joining the apparatus with the at least one apparatus, whereby a wattage generated by the apparatus and/or the at least one generator combine to form a sum wattage.

13. The generator of claim 1, wherein the power fluctuation module further comprises a transfer switch, the transfer switch being operable to switch the power between the apparatus and the electrical device during an interruption in the power.

14. The generator of claim 1, wherein the renewable energy power source comprises one or more of a solar panel and a wind turbine.

15. The generator of claim 1, wherein the power recharge module further comprises an alternating current cord, the alternating current cord being configured to join the apparatus with the at least one electrical device.

16. A system for storing, managing and distributing electrical current derived from renewable energy, the system comprising:
a rigid polymeric housing defining two or more recesses, including an output panel recess for receiving an output panel and an input panel recess for receiving an input panel, the rigid polymeric housing further defining two semicircular recesses, each semicircular recess for receiving a wheel, the housing defining two or more semicircular recesses for receiving wheels and a plurality of parallel elongated recesses in a top surface of the housing;
two or more wheels affixed to an axle, the axle driven by an electric adjustable-speed drive control system which comprises a motor and a controller, the controller comprising a twist handle rotatable to apply increasing torque to the axle;
an inverter;
the output panel comprising:
a nonconductive polymeric faceplate having a planar top surface;
four NEMA 110 volt A/C sockets recessed into the faceplate, each of the four NEMA 110 volt A/C sockets having a maximum output capacity of one of 15 amps and 20 amps;
one or more 220 volt A/C sockets recessed into the faceplate, the 220 volt A/C sockets having a maximum output capacity of 60 amps;
one or more 110 volt A/C sockets recessed into the faceplate, the 110 volt A/C sockets having a maximum output capacity of 30 amps;
a master switch adapted to shut down all power being input or output from the generator;
an invertor switch adapted to activate the inverter;
six or more LEDs, each LED adapted to indicate electrical connectivity between the generator and an external device;
an output D/C power meter adapted to display power being output by the generator to external devices;
an input D/C power meter adapted to display power being input to the generator by external sources;
the input panel comprising:
a nonconductive polymeric faceplate having a planar top surface;
a 220 volt A/C charge input;
a switch adapted to shut off all power being input to the generator;
a plurality of solar inputs for receiving current from one or more photovoltaic cells;
a 110 volt A/C charge socket;
a plurality of batteries for storing energy imparted to the generator via the input panel, each battery comprising a 12 volt, 225 ampere, sealed, deep cycle battery;
a power leverage module configured to at least partially convert the alternating current to the direct current;
a power linkage module configured to join the apparatus with one or more of one electrical device and at least one generator;
a power fluctuation module configured to at least partially restrict a fluctuation of the power and to alert to the fluctuation of the power;
a power recharge module configured to at least partially recharge the apparatus, the power recharge module comprising a renewable energy power source; and
a power display module configured to display a status of the power.

17. The system of claim 16, wherein the renewable energy power source comprises one or more of a solar panel and a wind turbine.

18. The system of claim 16, further comprising one more 48 volt Anderson connectors.

19. The system of claim 16, wherein the output panel comprises a plurality of resets, each reset adapted to open and close a circuit including only a single socket on the output panel.
